(19) United States
(12) Patent Application Publication
(10) Pub. No.: US 2023/0392420 A1
(43) Pub. Date: Dec. 7, 2023

(54) FENCE GATE LATCH

(71) Applicant: D.F. Eastwood Construction Corp. dba All Island Fence and Railings, Island ia, NY (US)

(72) Inventors: John Gaetano Ruggiero, Hauppauge, NY (US); Margaret Mary Fischetto, Merrick, NY (US); Donald Salvatore Fischetto, Merrick, NY (US)

(21) Appl. No.: 18/162,750

(22) Filed: Feb. 1, 2023

Related U.S. Application Data
(60) Provisional application No. 63/349,677, filed on Jun. 7, 2022.

(51) Int. Cl. E05C 19/12; E05B 65/00

(52) U.S. Cl. CPC E05C 19/12; E05B 65/0007

(57) ABSTRACT

A fence gate latch mechanism for a fence gate is presented having a gate post positioned adjacent a fence post such that a space is defined between the gate post and the fence post. The fence gate latch mechanism includes a base plate attached to a sidewall of the gate post or the fence post within the space and an L-shaped latching member pivotally attached to the base plate and having an upper arm and a lower arm operating as a latching mechanism, the L-shaped latching member being positioned in the space such that no portion of the L-shaped latching mechanism extends beyond a front or top surface of a gate.

### RELATED APPLICATION INFORMATION

This application claims priority to Provisional Application No. 63/349,677 filed on Jun. 7, 2022, incorporated herein by reference herein in its entirety.

### BACKGROUND

The present invention relates generally to fences and gate latches, and more specifically, to a safety gate latch that is inaccessible directly from the outside of the gate.

Fences often have gates to allow for entry and exit of fenced in areas. The gates are spring loaded, so they close themselves and include latches that maintain the gate in a closed position. These latches are often accessible from the outside and inside of the gate to allow a user to open the gate from either side.

The safety of fence gates, particularly those for fences used that enclose pools and pool areas, have become a very important safety consideration. It is becoming more and more of a trend that fence gates for pool areas must meet stringent local government requirements while still providing the necessary automatic closure and safety. In addition to requiring the fence gate to open outward, one of such requirements is that there can be no portion of the latch mechanism that protrudes from the outside surface of the gate and/or gate post.

The use of removable tensioned or automatically closing fences has increased greatly over the past several years. Such fences are typically used to enclose a swimming pool or other hazard and are intended to prevent access to such swimming pools or hazards by small children.

In general, these fences are comprised of a plurality of spaced apart poles, having a lower end inserted into holes in the deck or ground around the swimming pool, and a mesh screening material stretched between such poles. One or more so called “gates” are provided in the fence assembly by placing two of the poles immediately adjacent one another, with no mesh tensioned between such poles. A simple hook and eye latch is usually included to latch the two poles to one another to prevent small children from accessing the swimming pool. For further child safety, a hook and eye latch with a spring-loaded tang, tensioned to prevent opening by a child, is used.

Although somewhat effective for its intended purpose, this prior art structure has not proven to be entirely satisfactory. Specifically, the mere inclusion of a hook and eye latch to retain the two adjacent gate poles together is not, by itself, adequate to prevent children from opening the gate and accessing the swimming pool. The child or children only need to slide the hook up out of the eye to unlatch the two adjacent poles and gain access to the swimming pool. Although somewhat more effective, the use of a spring-loaded tang with the hook and eye latch has also not proven to be entirely satisfactory because the spring tension is oftentimes not great enough to prevent children from sliding the tang and lifting the hook out of the eye.

Accordingly, there is a need in the art for a safety latch which may not be unlatched by children or others for whom access to the swimming pool is not desired, as well as a safety latch for meeting the stringent local government requirements (i.e., no portion of the latch mechanism permitted to protrude from an outside surface of the gate and/or gate post).

### SUMMARY

In accordance with an embodiment, a fence gate latch mechanism is provided for a fence gate having a gate post positioned adjacent a fence post such that a space is defined between the gate post and the fence post. The fence gate latch mechanism includes a base plate attached to a sidewall of the gate post or the fence post within the space and an L-shaped latching member pivotally attached to the base plate and having an upper arm and a lower arm operating as a latching mechanism, the L-shaped latching member being positioned in the space such that no portion of the L-shaped latching mechanism extends beyond a front or top surface of the gate.

In accordance with another embodiment, a method for operating a fence gate latch mechanism for a fence gate having a gate post positioned adjacent a fence post such that a space is defined between the gate post and the fence post is provided. The method includes attaching a base plate to a sidewall of the gate post or the fence post within the space and pivotally attaching an L-shaped latching member to the base plate and having an upper arm and a lower arm operating as a latching mechanism, the L-shaped latching member being positioned in the space such that no portion of the L-shaped latching mechanism extends beyond a front or top surface of the gate.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1A illustrates a front view of a gate and a fence post, in accordance with an embodiment of the invention;

FIG. 1B illustrates a perspective view of the gate and the fence post of FIG. 1A, in accordance with an embodiment of the invention;

FIG. 2A illustrates the latch mechanism in the first or closed state, in accordance with an embodiment of the invention;

FIG. 2B illustrates the latch mechanism in the second or open state, in accordance with an embodiment of the invention;

FIG. 3A illustrates a perspective back view of the latch mechanism, in accordance with an embodiment of the invention;

FIG. 3B illustrates a back view of the latch mechanism latching to a locking pawl of a fence latch member, in accordance with an embodiment of the invention;

FIG. 4 illustrates a perspective view of the fence latch member, in accordance with an embodiment of the invention;

FIG. 5A illustrates the handle carrier resting on the gate, in accordance with an embodiment of the invention; and

FIG. 5B illustrates a perspective view of the handle carrier with the hooked handle (not resting on the gate), in accordance with an embodiment of the invention.

Throughout the drawings, same or similar reference numerals represent the same or similar elements.

### DETAILED DESCRIPTION

Embodiments in accordance with the present invention provide for a latch mechanism that is not visible and/or noticeable from the outside (or outside front surface) of the gate and/or gate post. Instead, the latch mechanism is confined between sidewalls of the gate post and fence post, and although certain portions of the latch mechanism may extend only beyond a back surface of the gate and gate post. As a result, the latch mechanism is not visible and/or noticeable from a front view of the gate as no components of the latch mechanism that protrude or extend outward from the front surface of the gate or gate post or fence post or the top of the gate or gate post or fence post.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

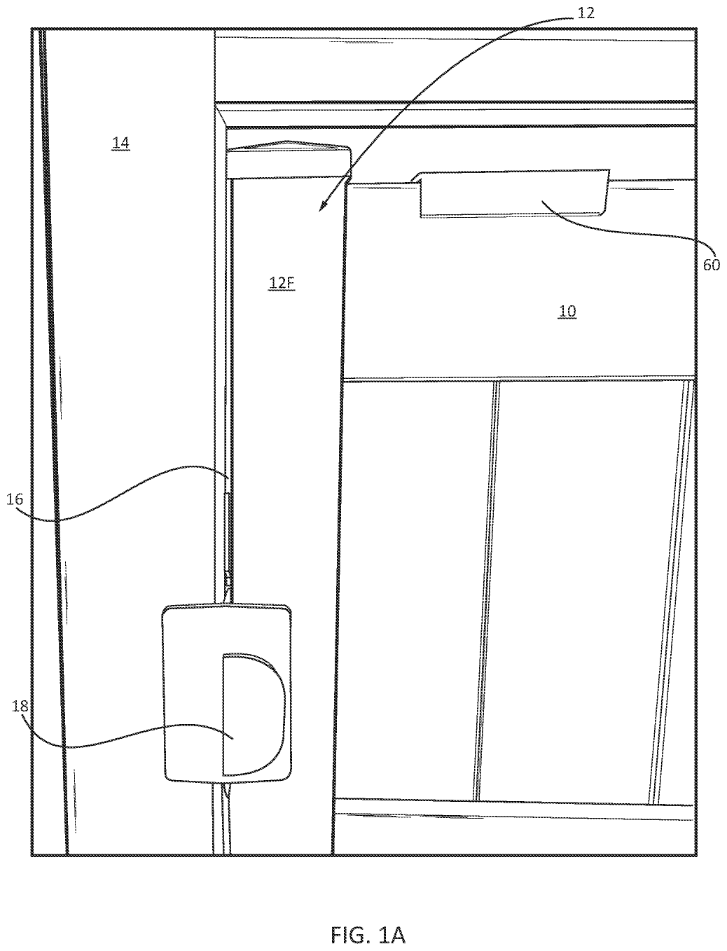

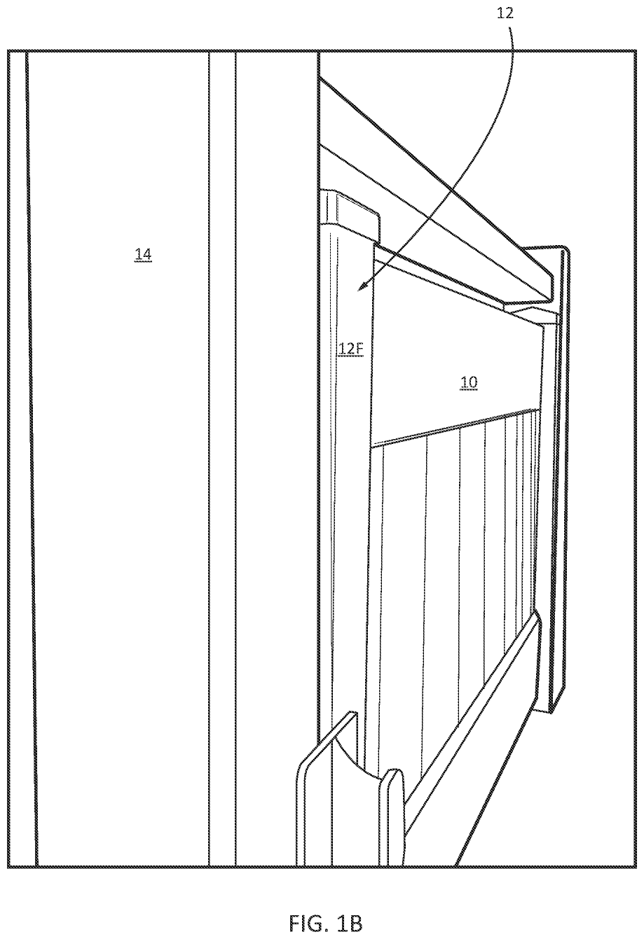

FIG. 1A illustrates a front view of a gate and a fence post, in accordance with an embodiment of the present invention.

Referring to FIG. 1A, wherein like reference numerals refer to like components in the various views, there is illustrated therein a new and improved latch mechanism that is confined within a space between the gate post and fence post.

A gate 10 includes a gate post 12. This is a front view of the gate 10 facing a front surface 12F of the gate post 12. The gate 10 is positioned within a fence having a fence post 14. The fence post 14 is shown adjacent the gate post 12. A spacing 16 is defined between gate post 12 and the fence post 14. The spacing 16 can be about 0.5 inch in most instances.

A handle 18 can be included, but the handle 18 plays no part in the latching of the gate 10 to the fence post 12. In addition, the handle 18 is not required in any way for the operation of the latch mechanism of the present invention or the gate 10 it is attached to. It is noted that a location of the handle 18 can be changed based on desired application.

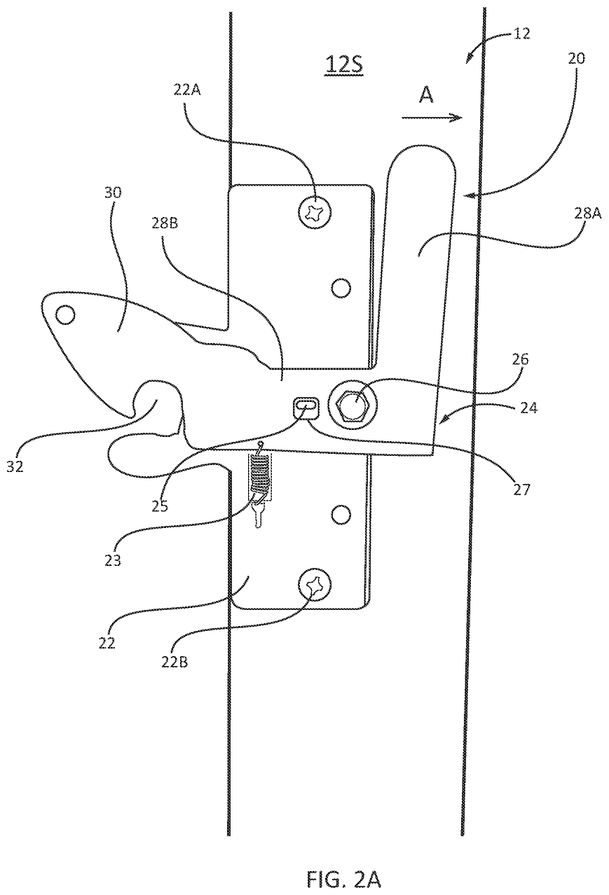

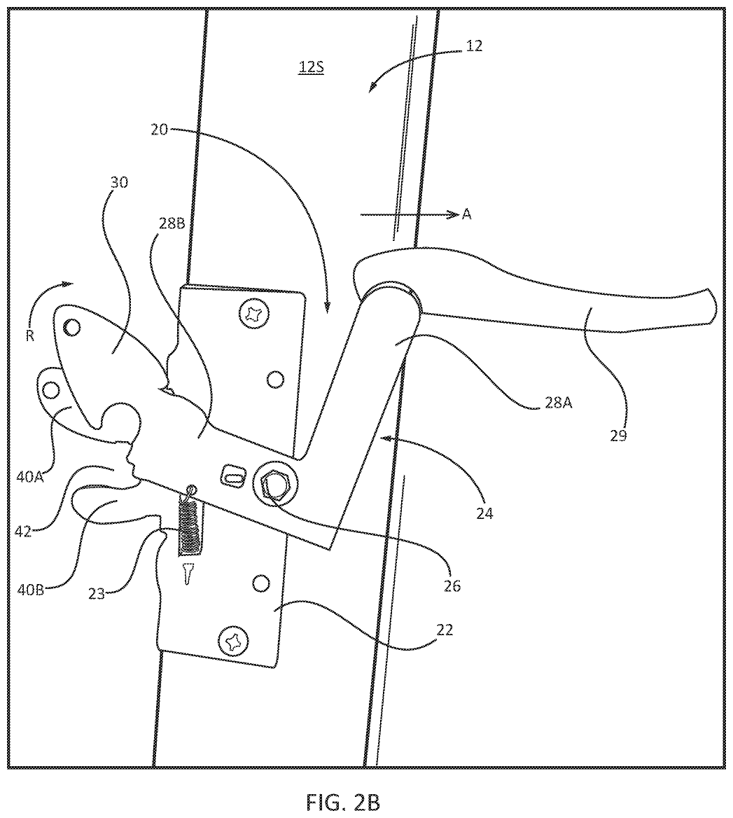

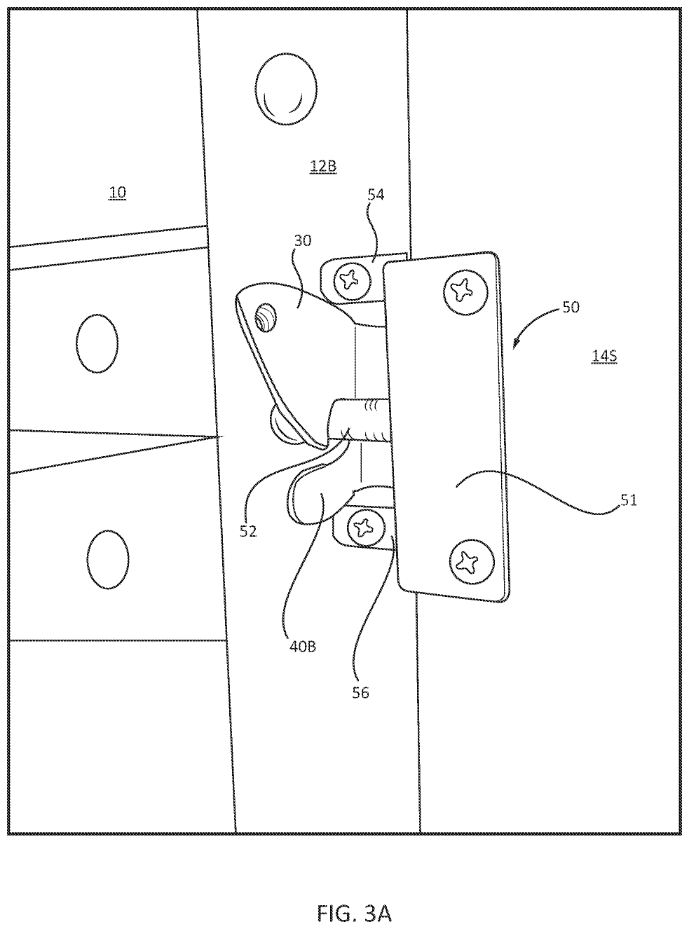

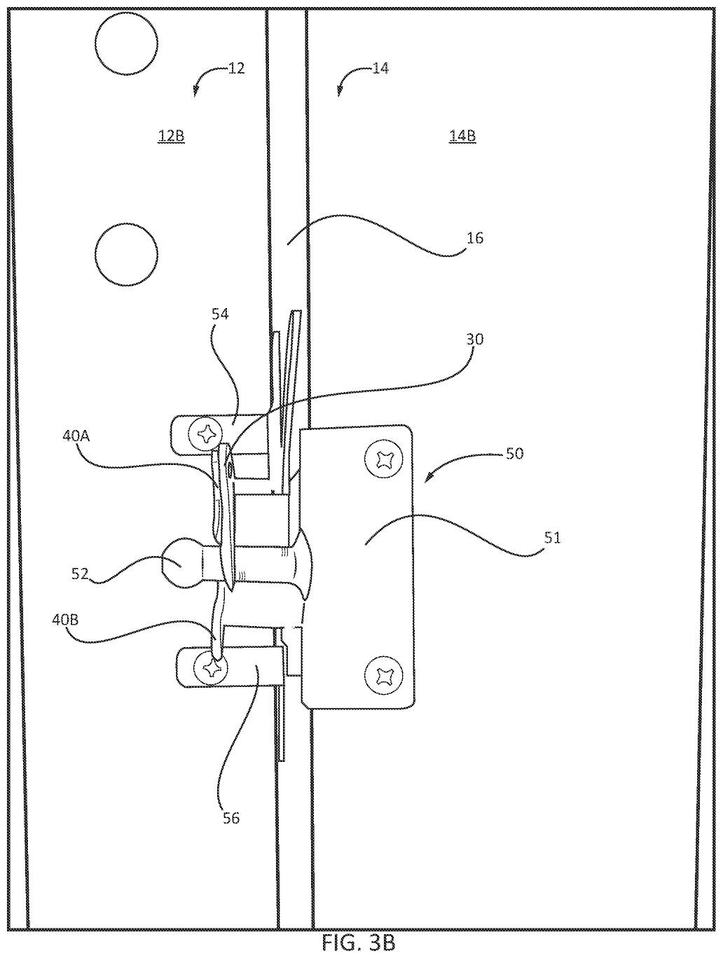

In accordance with a preferred implementation of the invention, the latch mechanism 20 (FIGS. 2A-3B) must fit within the space 16 while no portion of the latch mechanism can be accessible directly from the front side (or outside) of the gate 10 and/or gate post 12 and/or fence post 14. As can be seen in these figures, there is no latch mechanism or portion thereof that protrudes or extends beyond the front surface of gate 10 and/or the gate post 12 and/or the fence post 14. In addition, one portion of the latch mechanism 20 protrudes upward beyond a top of the gate post 12 of the fence post 14.

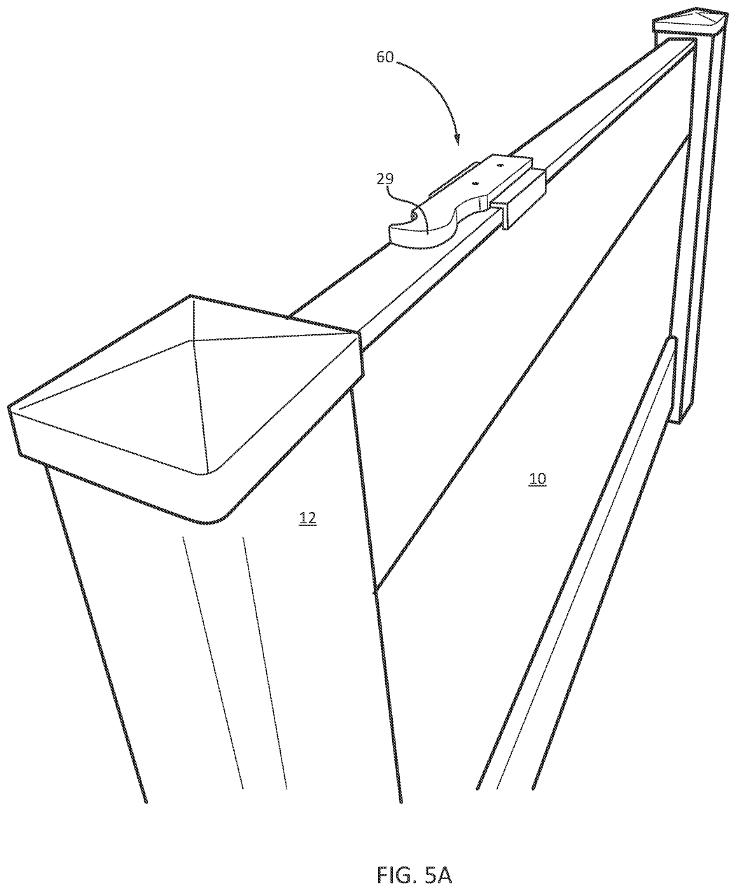

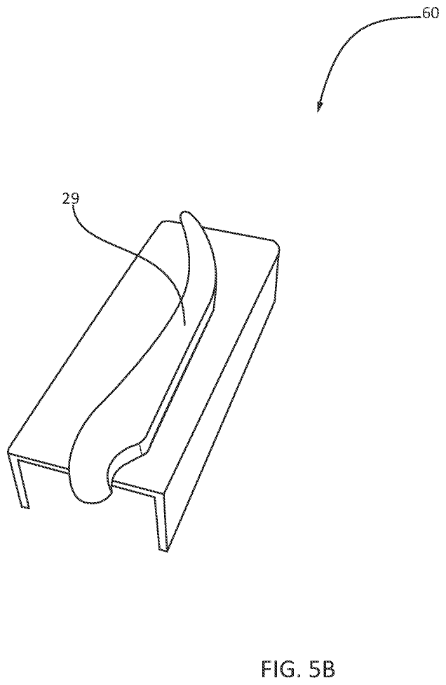

In one exemplary embodiment, a handle carrier 60 rests on the top surface of the gate 10. In other exemplary embodiments, the handle carrier 60 can rest on other portions surrounding the gate 10 and/or fence 14. In further exemplary embodiments, the handle carrier 60 can be stored in a location not associated with the gate 10 and/or fence 14, such as, e.g., a tool shed or a home of the user. In the instant illustrative example, the handle carrier 60 can be releasably attached to the top surface of the gate 10. The handle carrier 60 will be described in further detail with respect to FIGS. 5A-5B.

FIG. 1B illustrates a perspective view of the gate 10 and the fence post 14 of FIG. 1A, in accordance with an embodiment of the present invention. This view better illustrates how the gate 10 (with the gate post 12) can be mounted to the fence post 14.

FIG. 2A illustrates the latch mechanism in the first or closed state, in accordance with an embodiment of the present invention.

The latch mechanism 20 includes a base plate 22 fixedly attached to the sidewall or side surface 12S of the gate post 12. In one example, the base plate 22 can be fixedly attached to the side surface 12S of the gate post 12 by a first fixed point 22A and a second fixed point 22B. A substantially or generally L-shaped handle 24 is pivotably attached to the base plate 22 at fixed point 26. A distal end of the L-shaped handle 24 defines a latching member 30. The latching member 30 defines a hooked shape with an opening 32. The L-shaped handle 24 has an upper arm 28A and a lower arm 28B. The upper arm 28A can be moved in a direction “A” to actuate the latch mechanism 20 (FIG. 2B).

In one implementation, the base plate 22 can include a spring 23 connected thereto. The spring 23 can be positioned below the L-shaped handle 24 and aids in biasing the L-shaped handle 24 into a first position (closed position) to a second position (open position). The lower arm 28B of the L-shaped handle 24 further defines an opening 27 for receiving a tab 25. The tab 25 is fixed to the base plate 22. The tab 25 limits movement of the lower arm 28A.

In the first or closed state, the upper arm 28A of the L-shaped handle 24 remains confined within a width of the side surface 12S of the gate post 12. The latching member 30 extends beyond a back surface of the gate post 12.

FIG. 2B illustrates the latch mechanism in the second or open state, in accordance with an embodiment of the present invention.

In the open state, the upper arm 28A of the L-shaped handle 24 is actuated by a handle 29 supported by the handle carrier 60 (FIGS. 5A and 5B). The handle 29 is inserted into the space 16 and is configured to engage the top of and pull the upper arm 28A of the L-shaped handle 24 in a direction “A.” The L-shaped handle 24 pivots about fixed point 26 such that the latching member 30 can be angularly displaced. The latching member 30, e.g., moves in a direction “R.” The movement of the latching member 30 results in the exposure of an upper receiving portion 40A and a lower receiving portion 40B. The upper receiving portion 40A and the lower receiving portion 40B extend beyond a back surface of the gate post 12. The upper receiving portion 40A and the lower receiving portion 40B are fixed to the base plate 22. The upper receiving portion 40A and the lower receiving portion 40B are non-movable components. The upper receiving portion 40A and the latching member 30 are aligned with respect to each other when the gate 10 is in the closed state (FIG. 2A). However, in the open state, a force is applied to the upper arm 28A of the L-shaped handle 24 to trigger displacement of the latch mechanism 20. The displacement of the latch mechanism 20 occurs by the handle 29 extending into the space 16 defined between the gate post 12 and the fence post 14 to engage the upper arm 28A of the L-shaped handle 24. As a result, the upper receiving portion is now offset from the latching member 30 when the latch mechanism 20 is in an open state. A space 42 is defined between the upper receiving portion 40A and the lower receiving portion 40B. The spring 23 can be connected to the lower arm 28B to limit movement of the lower arm 28B within an angular area defined by the opening 27 accommodating the tab 25 and biasing the latch mechanism 20 into the closed state or position.

It is noted that the handle 29 is applied to the upper arm 28A when the gate 10 is closed or aligned with the fence post 14. In other words, the handle 29 is configured to fit within the space 16 (FIG. 1A) defined between the gate post 12 and the fence post 14.

As mentioned above, the spacing 16 between the gate post 12 and the fence post 14 can be as small as ½ inch. As such, and in accordance with one implementation of the invention, the handle 29 (FIG. 2B) is configured to fit between the gate post 12 and the fence post 14 and is further configured to engage the upper arm 28A to allow a user to pull on the same, and thereby open or unlock the latch mechanism 20 (i.e., the gate 10). In one example, the handle carrier or holder 60 is configured to be releasably secured to the top of the gate 10 such that the handle carrier 60 can be accessed and used as needed, and safely stored when not needed (FIG. 5A). However, in other example embodiments, the handle carrier 60 can be placed or positioned or stored in any other location, e.g., a shed or the home of the user. It is thus not necessary for the handle carrier 60 to be positioned on or near the gate 10 and/or the fence 14.

The latch mechanism 20 includes a base plate 22 attached to a sidewall of a gate post 12 of a gate 10, an L-shaped handle 24 pivotally attached to the base plate 22, a latching member 30 extending from a distal end of the L-shaped handle 24 and an upper receiving portion 40A and a lower receiving portion 40B disposed adjacent the latching member 30 such that the upper receiving portion 40A, the lower receiving portion 40B, and the latching member 30 collectively define an opening 42 to receive a locking pawl 52 of a fence latch member 50 (FIGS. 3A-3B). The latch mechanism 20, viewed from a front portion of the gate 10 when the gate 10 is in a closed state, is unnoticeable, and the L-shaped handle 24 remains concealed in a space 16 defined between the gate post 12 and the fence post 14.

Stated differently, a fence gate latch mechanism is provided for a fence gate having a gate post positioned adjacent a fence post such that a space is defined between the gate post and the fence post. The fence gate latch mechanism includes the base plate 22 attached to a sidewall of the gate post 12 or the fence post 14 within the space 16 and an L-shaped latching member 20 is pivotally attached to the base plate 22, and having an upper arm 28A and a lower arm 28B operating as a latching mechanism, the L-shaped latching member 20 being positioned in the space 16 such that no portion of the L-shaped latching mechanism 20 extends beyond a front or top surface of the gate 10.

FIG. 3A illustrates a perspective back view of the latch mechanism, in accordance with an embodiment of the present invention.

In the back view of the latch mechanism 20, the latch mechanism 20 is configured to cooperate with a fence latch member 50. The fence latch member 50 includes a plate 51 fixedly attached to the side surface 14S of the fence post 14.

The fence latch member 50 further includes a locking pawl 52 extending therefrom to be received within the space 42 or opening 32 defined between the latching member 30 and the lower receiving portion 40B. The hooked section of the latching member 30 engages the locking pawl 52 on the back surface 12B of the gate post 12. Additionally, the base plate 22 extends to the back side 12B of the gate post 12 and is attached thereto with a first hinge 54 and a second hinge 56. The first and second hinges 54, 56 are fixedly secured to the back surface 12B of the gate post 12. The first hinge 54 can be positioned above the latching member 30 and the second hinge 56 can be positioned below the lower receiving portion 40B.

FIG. 3B illustrates a back view of the latch mechanism latching to a locking pawl of a fence latch member, in accordance with an embodiment of the present invention.

The back view further illustrates the latch mechanism 20 latching to the locking pawl 52 of the fence latch member 50. The latching member 30 is horizontally aligned with the upper receiving portion 40A. Stated differently, the latching member 30 is directly adjacent the upper receiving portion 40A. The first hinge 54 and the second hinge 56 of the base plate 22 are better illustrated attached to the back side 12B of the gate post 12.

The plate 51 of the fence latch member 50 is also better illustrated attached to the back side 14B of the fence post 14. Additionally, the spacing 16 between the gate post 12 and the fence post 14 is visible from the back side. It is noted that the base plate 22 and the L-shaped handle 24 are confined between the gate post 12 and the fence post 14. Stated differently, the base plate 22 and the L-shaped handle 24 are concealed within a width of the gate post 12 and/or a width of the fence post 14. Only the latching member 30, the upper receiving portion and the lower receiving portions 40B extend beyond the back side 12B of the gate post 12.

Therefore, a fence latching assembly includes a fence latch member 50 attached to a fence post 14 of a fence, the fence latch member 50 including a locking pawl 52 and a latch mechanism 20 configured to cooperate with the fence latch member 50, the latch mechanism 20 including a base plate 22 attached to a sidewall of a gate post 12 of a gate 10, an L-shaped handle 24 pivotally attached to the base plate 22, a latching member 30 extending from a distal end of the L-shaped handle 24 and an upper receiving portion 40A and a lower receiving portion 40B disposed adjacent the latching member 30 such that the upper receiving portion 40A, the lower receiving portion 40B, and the latching member 30 collectively define an opening 42 to receive the locking pawl 52 of the fence latch member 50. The latch mechanism 20, viewed from a front portion of the gate 10 when the gate 10 is in a closed state, is unnoticeable, and the L-shaped handle 24 remains concealed in a space 16 defined between the gate post 12 and the fence post 14.

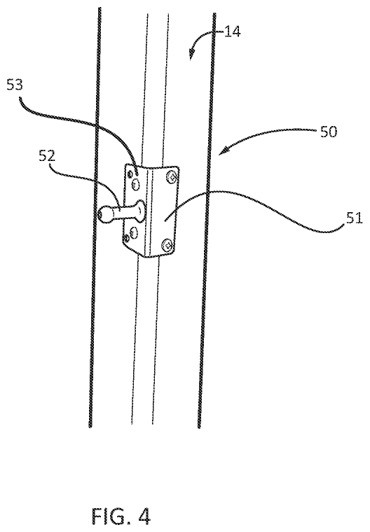

FIG. 4 illustrates a perspective view of the fence latch member, in accordance with an embodiment of the present invention.

The fence latch member 50 is shown when the gate 10 is opened. The fence latch member 50 includes the plate 51 and a plate 53 from which the locking pawl 52 extends from. The locking pawl 52 is parallel to the gate post 12 and the fence post 14.

FIG. 5A illustrates the handle carrier 60 resting on the gate, in accordance with an embodiment of the present invention.

In one example, the handle carrier or holder 60 with the handle 29 can be configured to be releasably secured to the top of the gate 10 such that the handle carrier 60 can be accessed and used as needed, and safely stored when not needed. However, one skilled in the art can contemplate placing the handle carrier 60 in any location desired by the user.

FIG. 5B illustrates a perspective view of the handle carrier with the hooked handle 29 (not resting on the gate), in accordance with an embodiment of the present invention.

The handle carrier 60 with the handle 29 is shown detached from the gate 10. The handle 29 has a hooked configuration such that it can cooperate with the curved surface of the upper arm 28A of the L-shaped handle 24. The handle 29 is shaped and dimensioned to engage the upper arm 28A to pull the upper arm 28A in a direction “A” to angularly displace the latching member 30 (FIG. 2B).

Those of skill in the art will appreciate that when the gate 10 is closed, the latching member 30 of the latch mechanism 20 is configured to hit or strike the locking pawl 52 and move upward against the spring bias (from spring 23) and cause the locking pawl 52 to be received into the spacing 42 between the upper and lower receiving portions 40A and 40B. Once the locking pawl 52 reaches the space 32 in the latching member 30, the latch mechanism 20 closes down on the pawl 52 and locks the same, thereby locking the gate 10.

In summary, the exemplary embodiments provide for a latch mechanism that is not visible or not noticeable from the outside (or front surface) of the gate. The latch mechanism is confined between sidewalls of the gate post and fence post, and certain portions of the latch mechanism extend beyond a back surface of the gate post and gate. As a result, the latch mechanism is not visible from a front view of the gate as no components of the latch mechanism protrude or extend beyond the front surface of the gate or gate post or fence post or above the gate, gate post and/or fence post. Stated differently, a latch mechanism for a fence gate is presented where no portion of the latch mechanism protrudes beyond the front or outside surface of fence gate and/or an adjacent fence post. Further, the latch mechanism for the fence gate where the latch mechanism can be positioned in a space no greater than ½ inch while no portion of the latch mechanism protrudes beyond the front or outside surface of fence gate and/or an adjacent fence post.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

1. A fence gate latch mechanism for a fence gate having a gate post positioned adjacent a fence post such that a space is defined between the gate post and the fence post, the fence gate latch mechanism comprising:
a base plate attached to a sidewall of the gate post or the fence post within the space; and
an L-shaped latching member pivotally attached to the base plate and having an upper arm and a lower arm operating as a latching mechanism, the L-shaped latching member being positioned in the space such that no portion of the L-shaped latching mechanism extends beyond a front or top surface of a gate.

2. The fence gate latch mechanism of claim 1, wherein the upper arm of the L-shaped latching member is confined within a width of the gate post or the fence post.

3. The fence gate latch mechanism of claim 1, wherein the lower arm of the L-shaped latching member has an upper receiving portion and a lower receiving portion extending from a distal end thereof.

4. The fence gate latch mechanism of claim 3, wherein the upper receiving portion and the lower receiving portion extend beyond a back surface of the gate post.

5. The fence gate latch mechanism of claim 3, wherein the upper receiving portion and the lower receiving portion are fixed to the base plate.

6. The fence gate latch mechanism of claim 3, wherein the upper receiving portion and the lower receiving portion are non-movable components.

7. The fence gate latch mechanism of claim 1, wherein an external force is applied to the upper arm of the L-shaped latching member to displace the L-shaped latching member to an open state.

8. The fence gate latch mechanism of claim 7 further comprising a removable handle, wherein the external force applied to the upper arm is generated by the removable handle manually operated by a user.

9. The fence gate latch mechanism of claim 8, wherein the removable handle is a separate piece that the user places into the space defined between the gate post and the fence post to engage the upper arm of the L-shaped latching member.

10. The fence gate latch mechanism of claim 8, further comprising a handle carrier configured to be removably mounted to a top surface of the gate.

11. The fence gate latch mechanism of claim 1, wherein the base plate includes a spring connected thereto.

12. The fence gate latch mechanism of claim 11, wherein the spring is configured to bias the L-shaped latching member into a closed position.

13. The fence gate latch mechanism of claim 12, wherein the lower arm of the L-shaped latching member further comprises an opening to receive a tab.

14. The fence gate latch mechanism of claim 13, wherein the tab is fixed to the base plate and operates to limit movement of the lower arm of the L-shaped latching member.

15. A method for operating a fence gate latch mechanism for a fence gate having a gate post positioned adjacent a fence post such that a space is defined between the gate post and the fence post, the method comprising:
attaching a base plate to a sidewall of the gate post or the fence post within the space; and
pivotally attaching an L-shaped latching member to the base plate and having an upper arm and a lower arm operating as a latching mechanism, the L-shaped latching member being positioned in the space such that no portion of the L-shaped latching mechanism extends beyond a front or top surface of a gate.

16. The method of claim 15, wherein the upper arm of the L-shaped latching member is confined within a width of the gate post or the fence post.

17. The method of claim 15, wherein the lower arm of the L-shaped latching member has an upper receiving portion and a lower receiving portion extending from a distal end thereof.

18. The method of claim 15, wherein an external force is applied to the upper arm of the L-shaped latching member to displace the L-shaped latching member to an open state.

19. The method of claim 18, further comprising a removable handle, wherein the external force applied to the upper arm is generated by the removable handle manually operated by a user.

20. The method of claim 19, wherein the removable handle is a separate piece that the user places into the space defined between the gate post and the fence post to engage the upper arm of the L-shaped latching member.
